(19) United States
(12) Patent Application Publication
(10) Pub. No.: US 2013/0280943 A1
(43) Pub. Date: Oct. 24, 2013

(54) SERVER SYSTEM AND NETWORK CABLE CONNECTING DEVICE THEREOF

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: CHENG-FEI WENG, Shenzhen (CN); ZHENG-HENG SUN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/862,862

(22) Filed: Apr. 15, 2013

(30) Foreign Application Priority Data
Apr. 20, 2012 (CN) 201210116813.8

(51) Int. Cl. H04L 12/66

(52) U.S. Cl. CPC H04L 12/66
USPC 439/358

(57) ABSTRACT

A network cable connecting device configured to connect a network cable to a server includes a holder, a base, and a circuit board. The base includes a first surface and an opposite second surface. The latching portion protrudes from the first surface of the base. The securing portion is formed on the second surface of the base and secured to the server. The circuit board is received in the latching portion and electrically connected to the server. The circuit board includes a network port for connecting the network cable.

### BACKGROUND

1. Technical Field

The disclosure generally relates to server systems and network cable connecting devices thereof, and particularly to a server system having orderly arranged network cables and a network cable connecting device of the server system.

2. Description of Related Art

Server systems commonly include a case and a plurality of servers. The case defines a plurality of receiving units. Each server is received in one of the receiving units and usually includes a network port configured to connect the server to an external terminal device by a network cable.

However, in above-mentioned structure, a huge number of the network cables may be randomly positioned in the case and often easy to appear chaotic. In addition, the huge number of network cables may occupy a relative larger space of the case, even block an air inlet of the case, and reduce heat dissipation efficiencies of the servers.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a block diagram of a server system, according to an exemplary embodiment of the disclosure.

FIG. 2 is an exploded view of a network cable connecting device, according to the exemplary embodiment of the disclosure.

FIG. 3 is a schematic view of the network cable connecting device of FIG. 2 mounted on a server of the server system of FIG. 1, according to the exemplary embodiment of the disclosure.

### DETAILED DESCRIPTION

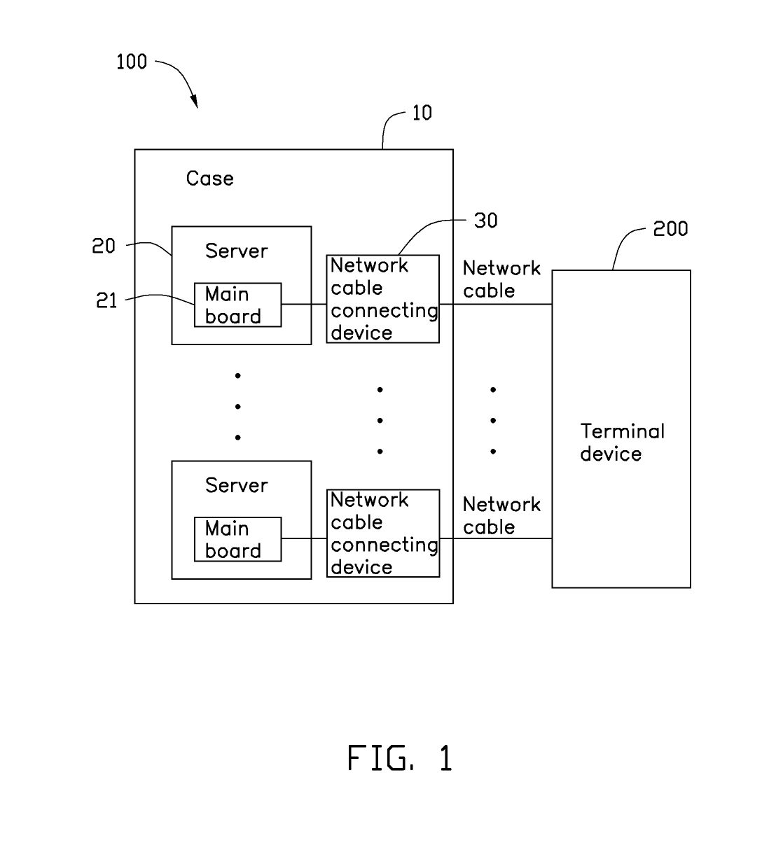

FIG. 1 is a block diagram of a server system 100, according to an exemplary embodiment of the disclosure. The server system 100 includes a case 10, a plurality of servers 20 received in the case 10, and a plurality of network cable connecting devices 30 corresponding to the servers 20 configured to connect the corresponding servers 20 to an external terminal device 200, such as a computer by network cables.

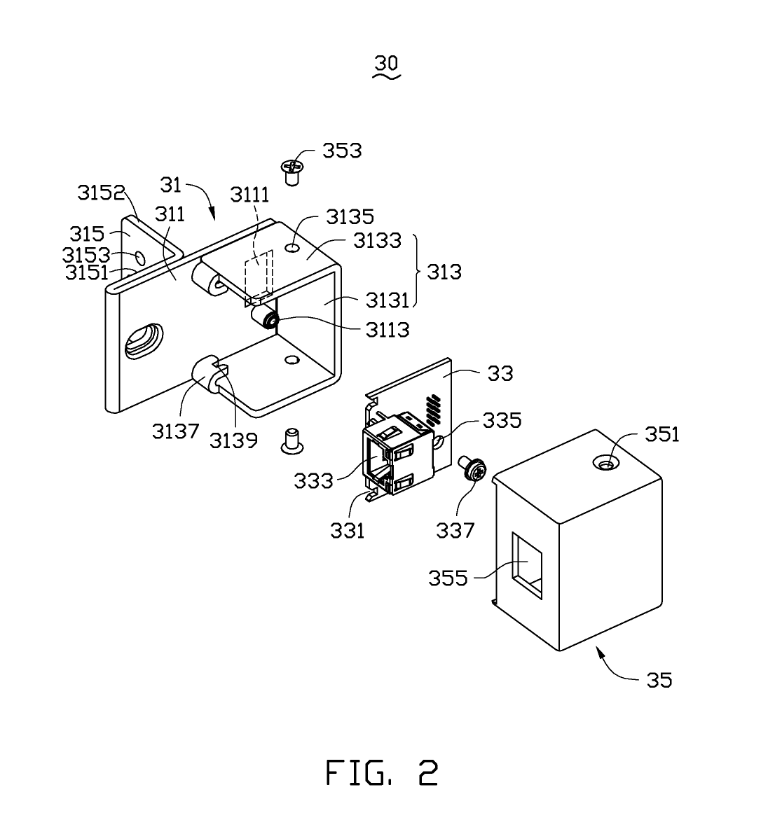

Referring to FIG. 2, each network cable connecting device 30 includes a holder 31, a circuit board 33, and a cover 35.

The holder 31 includes a base 311, a latching portion 313, and a securing portion 315. The base 311 is substantially a rectangular board. A substantial rectangular though hole 3111 is defined in a first side of the base 311 communicating with the case 10. The hole 3111 is configured for wires (not shown) of the circuit board 33 to enter into the case 10 thereby interconnecting the circuit board 33 and a main board 21 (schematically shown in FIG. 1) of the corresponding server 30. A mounting post 3113 protrudes from the first side of the base 311 adjacent to the hole 3111 and is configured to secure the circuit board 33 to the base 311.

The latching portion 313 is substantially U-shaped and includes a connecting plate 3131 and two opposite latching plates 3133 perpendicularly connecting to the connecting plate 3131. The connecting plate 3131 and the latching plates 3133 are perpendicularly extended from a first surface of the base 311 and partially surrounding the base 311. Each latching plate 3133 defines a first securing hole 3135 opposite to each other configured to secure the cover 35 to base 11. A hook 3137 is bent from one side of each latching plate 3133 opposite to the connecting plate 3131. Each hook 3137 defines a latching slot 3139 to engage with the circuit board 33.

The securing portion 315 is substantially L-shaped and includes a bent plate 3151 and a securing plate 3152 perpendicularly connecting to the bent plate 3151. The bent plate 3151 is formed by bending an end of the base 311 along a direction opposite to the latching portion 313 about 360 degrees and overlapped on a second surface of the base 311 opposite to the latching portion 313. The securing plate 3152 is perpendicularly bent from an end of the bent plate 3151. A securing hole 3153 is defined in the securing plate 3152 and configured to secure the holder 313 to the server 20.

The circuit board 33 defines two cuts 331 at one side of the circuit board 33 corresponding to the latching slots 3139. The cuts 331 engage with the latching slots 3139 to secure the circuit board 33 to the holder 31. A network port 333 is positioned at the side of the circuit board 333 and configured to connect a network cable. A mounting hole 335 is defined in the circuit board 33 corresponding to the mounting post 3113. A fastener 337 such as a screw bolt can screw into the mounting post 3113 and the mounting hole 335 and further secures the circuit board 33 to the holder 31.

The cover 35 corresponds to the latching portion 313 and is configured to cover the latching portion 313. The cover 35 defines two second screw holes 351 at two opposite sides of the cover 35 corresponding to the first screw holes 3135 and also defines an opening 355 corresponding network port 333. A fastener 353 such as a screw bolt can extend through the first screw holes 3135 and the second screw holes 351 to secure the cover 35 to the holder 31. When the cover 35 is covered on the holder 31, the opening 355 aligns with the network port 333 so that the network port 333 is exposed from the opening 355 to receive the network cable.

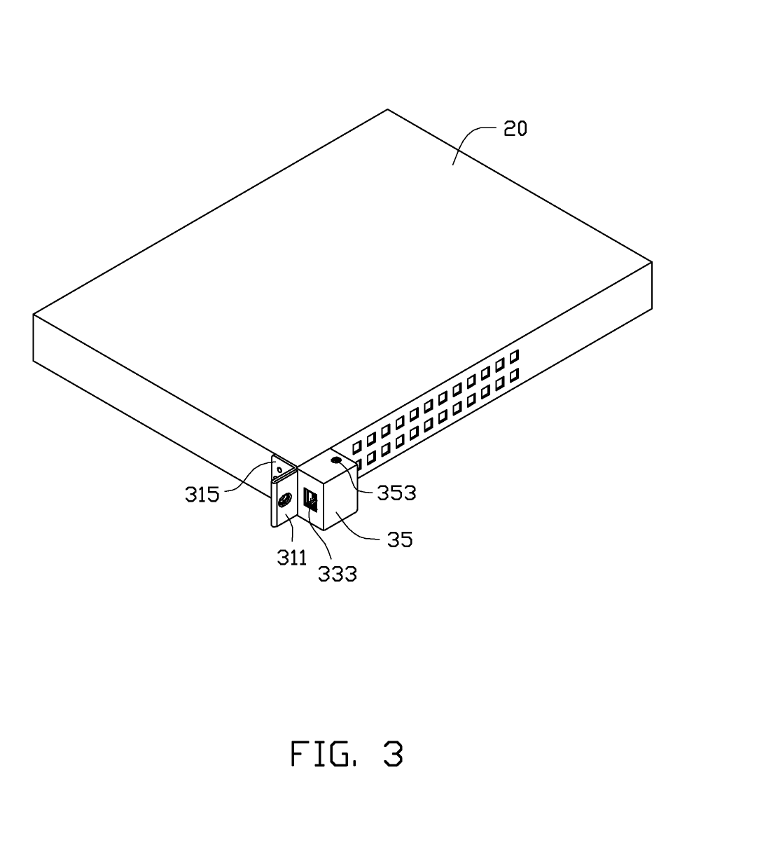

Referring to FIG. 3, to assemble the network cable connecting device 30, the holder 31 is positioned at an angle of the server 20 with the securing plate 3152 and a portion of the base 311 correspondingly attaching to two adjacent surfaces of the server 20. The securing plate 3152 is secured to the server 20 with the hole 3111 aligning with the main board 21. The circuit board 33 is received in the latching portion 313 with the cuts 331 engaging with the latching slots 3139. The fastener 337 is screwed into the mounting hole 335 and the mounting post 3113 to further secure the circuit board 33 to the holder 31. The wires of the circuit board 33 pass through the hole 3111 to connect to the main board 21 thereby interconnecting the circuit board 33 with the corresponding server 20. The cover 35 covers the base 311 with the second screw holes 351 aligning with the first screw holes 3135. The fasteners 353 are screwed into the first screw holes 3135 and the second screw holes 351 to secure the cover 35 to the holder 31. The opening 355 aligns with the network cable port 333 so that the network port 333 is exposed from the opening 355. An end of the network cable can connect to the server 20 by plugging into the network cable port 333 and another end of the network cable can connect to the terminal device 200.

Therefore, the servers 20 can connect to the terminal device 200 by directly plugging the network cables into the network cable ports 333 to avoid an excess of network cables. In addition, the network cables can be orderly positioned through the network cable connecting devices 30 and are prevented from occupying much space of the case 10 or blocking an air inlet of the case 10.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A network cable connecting device configured to connect a network cable to a server, the network cable connecting device comprising:
a holder comprising:
a base having a first surface and an opposite second surface;
a latching portion protruding from the first surface of the base; and
a securing portion formed on the second surface of the base and secured to the server; and
a circuit board received in the latching portion and electrically connected to the server, the circuit board comprising a network port for connecting the network cable.

2. The network cable connecting device of claim 1, wherein the latching portion comprises a connecting plate and two latching plates connecting to the connecting plate, the connecting plate and the latching plates protrude from an edge of the base and partially surrounding the base, an end of each latching plate opposite to the connecting plate comprises a hook, each hook defines a latching slot; the circuit board defines two cuts corresponding to the latching slots, the cuts engage with the corresponding latching slots.

3. The network cable connecting device of claim 2, wherein the base further comprises a mounting post, and the circuit board defines a mounting hole corresponding to the mounting post, the circuit board is secured to the base by a first fastener screwed into the mounting hole and the mounting post.

4. The network cable connecting device of claim 1, further comprises a cover corresponding to the latching portion, wherein the cover is secured to the latching portion and covers the latching portion.

5. The network cable connecting device of claim 4, wherein the latching portion defines two opposite first securing holes, the cover defines two second securing holes corresponding to the first securing holes, the cover is secured to the latching portion by second fasteners screwed into the first securing holes and the corresponding second securing holes.

6. The network cable connecting device of claim 4, wherein the cover further defines an opening aligning with the network port, the network port is exposed from the opening.

7. The network cable connecting device of claim 1, wherein the base defines a hole, the circuit board is electrically connected to the server through the hole.

8. The network cable connecting device of claim 1, wherein the securing portion comprises a bent plate and a securing plate perpendicular connected to the bent plate, the bent plate is formed by bending an end of the base along a direction opposite to the latching portion about 360 degrees and overlapped on the second surface of the base, the securing plate is perpendicularly bent from an end of the bent plate and secured to the server.

9. A server system, comprising:
a case;
a plurality of servers received in the case; and
a plurality of network cable connecting devices corresponding to the servers, each network cable connecting device comprising:
a holder, comprising:
a base having a first surface and an opposite second surface;
a latching portion protruding from the first surface; and
a securing portion sent from the second surface and secured to the server; and
a circuit board received in the latching portion and electrically connected to the server, the circuit board comprising a network port for connecting the network cable.

10. The server system of claim 9, wherein the latching portion comprises a connecting plate and two latching plates connecting to the connecting plate, the connecting plate and the latching plates protrude from an edge of the base and partially surrounding the base, an end of each latching plate opposite to the connecting plate comprises a hook, each hook defines a latching slot; the circuit board defines two cuts corresponding to the latching slots, the cuts engage with the corresponding latching slots.

11. The server system of claim 10, wherein the base further comprises a mounting post, and the circuit board defines a mounting hole corresponding to the mounting post, the circuit board is secured to the base by a first fastener screwed into the mounting hole and the mounting post.

12. The server system of claim 9, further comprises a cover corresponding to the latching portion, the cover is secured to the latching portion and covers the latching portion.

13. The server system of claim 12, wherein the latching portion defines two opposite first securing holes, the cover defines two second securing holes corresponding to the first securing holes, the cover is secured to the latching portion by second fasteners screwed into the first securing holes and the corresponding second securing holes.

14. The server system of claim 13, wherein the cover further defines an opening aligning with the network port, the network port is exposed from the opening.

15. The server system of claim 9, wherein the base defines a hole, the circuit board is electrically connected to the server through the hole.

16. The server system of claim 9, wherein the securing portion comprises a bent plate and a securing plate perpendicular connected to the bent plate, the bent plate is formed by bending an end of the base along a direction opposite to the latching portion about 360 degrees and overlapped on the second surface of the base, the securing plate is perpendicularly bent from an end of the bent plate and secured to the server.
